(19) United States
(12) Patent Application Publication
(10) Pub. No.: US 2007/0272882 A1
(43) Pub. Date: Nov. 29, 2007

(54) Optical distance measuring device and manufacturing method therefor

(75) Inventors: Takehisa Ishihara, Kashihara-shi (JP); Takayuki Taminaga, Kitakatsuragi-gun (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/798,690

(22) Filed: May 16, 2007

(30) Foreign Application Priority Data
May 24, 2006 (JP) 2006-143944
Mar. 29, 2007 (JP) 2007-088390

(51) Int. Cl. G01N 21/86; G01V 8/00

(52) U.S. Cl. 250/559.29; 250/559.36

(57) ABSTRACT

In the optical distance measuring device of the invention, a second optical path is formed by a transparent resin formed in a region where a light emitting element and a second light receiving part are connected directly to each other. As the temperature increases, the length of the optical path increases while its refractive index decreases, so that the optical path length itself becomes generally constant. Therefore, the length of the second optical path can be kept generally constant independently of temperature. Further, a first light receiving part for a first optical path and a second light receiving part for the second optical path 18 are formed in one identical light receiving element. Therefore, characteristic variations of the first light receiving part and the second light receiving part due to temperature can be reduced. This optical distance measuring device can achieve high distance measuring accuracy even under environments of intense temperature changes.

### CROSS-REFERENCE TO RELATED APPLICATIONS

This nonprovisional application claims priority under 35 U.S.C. §119(a) on Patent Application No. 2006-143944 filed in Japan on May 24, 2006 and Patent Application No. 2007-088390 filed in Japan on Mar. 29, 2007, the entire contents of which are hereby incorporated by reference.

### BACKGROUND OF THE INVENTION

The present invention relates to an optical distance measuring device, as well as a manufacturing method therefor, for measuring a distance ranging to a measuring object based on two optical paths, a first optical path along which light emitted from a light emitting element is reflected by the measuring object to reach a light receiving element and a second optical path along which light emitted from a light emitting element reaches a light receiving element.

Conventionally, the so-called TOF (Time Of Flight) method, which is a method for calculating a distance ranging to a measuring object by measuring a turnaround (go-and-return) time of light has been widely known as a distance measuring method. This distance measuring method is a method for, based on the velocity c of light, which is known as 3.0×10⁸ m/s, measuring the turnaround time t1 of light to calculate the distance L ranging to the measuring object by the following Equation (1):

L=(c·t1)/2 (1)

Various concrete signal processing techniques for the TOF method have been proposed. For example, in a distance measuring device disclosed in JP H6-18665 A (Document 1), with a start pulse (synchronized with the light emitting element) used as a start signal, an integrator continues to be electrically charged (or discharged) until a stop pulse (light reception signal) is detected so that the light turnaround time is detected from an increase (or a decrease) amount of electric charge. Such a method for measuring the time between a start pulse and a stop pulse is shown, for example, in a distance measuring device disclosed in JP H7-294642 A (Document 2), in which counting of the number of reference CLK pulses is started in synchronization with a start pulse and then a light turnaround time is obtained based on a pulse count resulting when a stop pulse is detected.

In any one of these methods, distance information is obtained by processing a detection signal derived from a light receiving element that detects light reflected by a distance measuring object. In this processing, errors in distance information may occur due to variations in response speed of the light emitting element, variations in response speed of the light receiving element, characteristic changes of the two elements caused by environmental (primarily, temperature) or other influences, and the like.

Accordingly, in view of reducing such errors as described above, with the use of a first optical path along which light emitted from the light emitting element is reflected by the measuring object and detected by a light receiving element as well as a second optical path, other than the first optical path, along which light emitted from the light emitting element is detected by the light receiving element, distance information calculated based on the first optical path can be corrected by referencing the second optical path, provided that a length of the second optical path is known and invariable. For this purpose, various distance measuring devices using the second optical path have been proposed including a distance measuring device disclosed in JP 3225682 A (Document 3), a distance measuring device disclosed in JP 2002-286844 A (Document 4), and a pulse-system electro-optical distance meter disclosed in JP 2896782 A (Document 5).

However, the conventional distance measuring devices disclosed in Documents 3 to 5 have such problems as shown below.

That is, the second optical path is formed by a mirror and a prism in the distance measuring device disclosed in Document 3, by a light guide member in the distance measuring device disclosed in Document 4, and by optical fiber in the pulse-system electro-optical distance meter disclosed in Document 5.

As described above, for the correction of distance information calculated based on the first optical path, it is of importance that the length of the second optical path keeps constant at all times. Generally, with increasing temperature, the length of an optical path increases due to its thermal expansion. However, in the conventional distance measuring devices disclosed in Documents 3 to 5, there is no description as to the thermal expansion of the second optical path. Furthermore, since the second optical path is formed by bulk optical elements, the distance measuring device is so large-sized as to be structurally unsuitable for use in electronic equipment.

### SUMMARY OF THE INVENTION

Accordingly, an object of the present invention is to provide a small-sized optical distance measuring device, as well as a manufacturing method therefor, which is capable of obtaining a high distance measuring accuracy even under environments in which intense temperature changes are involved.

In order to achieve the above object, there is provided an optical distance measuring device comprising:

a light emitting element;

a light receiving element for receiving light emitted from the light emitting element;

a first optical system for forming a first optical path which allows light emitted from the light emitting element to be reflected by a measuring object so as to reach the light receiving element;

a second optical system for forming a second optical path which allows light emitted from the light emitting element to reach the light receiving element without being reflected by the measuring object; and

distance information calculation means for obtaining distance information as to a distance ranging to the measuring object based on a signal outputted from the light receiving element upon reception of light that has passed through the first optical path and a signal outputted from the light receiving element upon reception of light that has passed through the second optical path, wherein

the second optical system includes a transparent resin which is in direct contact with a light emitting part of the light emitting element and a light receiving part of the light receiving element to lead part of light emitted from the light emitting part to the light receiving part.

An optical path length is given by a product of a length of an optical path and a refractive index of the optical path. In the case where the optical path is provided by a transparent resin, as the temperature increases, the length of the optical path increases while the refractive index of the optical path decreases, so that the optical path length itself holds generally constant. In this case, the second optical system forming the second optical path is formed by including a transparent resin that makes direct contact with the light emitting part of the light emitting element and the light receiving part of the light receiving element. Therefore, the second optical path, which is formed of the transparent resin, keeps generally constant in length independently of temperature, so that errors of resulting distance information due to temperature can be reduced.

In one embodiment of the invention, the light receiving part of the light receiving element is provided in plurality, some of the plurality of light receiving parts being optically coupled with the first optical system and the others of the light receiving parts being optically coupled with the second optical system.

In this embodiment, the light receiving parts optically coupled with the first optical system and the light receiving parts optically coupled with the second optical system are provided in one identical light receiving element. Therefore, as compared with the case where the light receiving parts optically coupled with the first optical system and the light receiving parts optically coupled with the second optical system are provided in different light receiving elements, characteristic variations of the individual light receiving parts due to temperature are reduced. As a result, errors of resulting distance information due to temperature can be further reduced. Besides, as compared with the case where the light receiving element is used in plurality, the optical distance measuring device can be reduced in size to more extent.

In one embodiment of the invention, the optical distance measuring device further includes:

a first lens for a light emitting element and a second lens for a light receiving element, the first lens and the second lens forming part of the first optical system and being formed of a transparent resin on the light shielding resin;

a first transparent resin which forms part of the first optical system and which is in direct contact with the light emitting element;

a second transparent resin which forms part of the first optical system and which is in direct contact with the light receiving element; and

two windows provided in the light shielding resin just under the first lens and the second lens, wherein

the first lens and the first transparent resin are in direct contact with each other via one of the windows provided in the light shielding resin, and

the second lens and the second transparent resin are in direct contact with each other via the other of the windows provided in the light shielding resin.

In this embodiment, the first lens for the light emitting element is in direct contact with the first transparent resin that is in direct contact with the light emitting element, while the second lens for the light receiving element is in direct contact with the second transparent resin that is in direct contact with the light receiving element. Therefore, any air layer between the first lens and the light emitting element, as well as between the second lens and the light receiving element, can be eliminated. Thus, reflection of light that may occur at boundaries with an air layer can be reduced.

In one embodiment of the invention, the light emitting element is a light emitting diode.

In this embodiment, the directivity of the light emitting diode is as wide as 60° in half value. Therefore, light that is emitted from the light emitting part of the light emitting element and that does not become incident on the first optical system forming the first optical path is repeatedly reflected so as to be incident on the second optical system forming the second optical path, and thus led to the light receiving part of the light receiving element.

In one embodiment of the invention, the light emitting element is a vertical cavity surface emitting laser, and

a portion of the transparent resin that forms part of the second optical system and that is in direct contact with the light emitting part of the light emitting element is a scattering transparent resin.

The directivity of the vertical cavity surface emitting laser is as narrow as 15° in half value. Therefore, light that is emitted from the light emitting part of the light emitting element and that does not become incident on the first optical system forming the first optical path never becomes incident on the second optical system forming the second optical path. In this embodiment, the part of the transparent resin that makes direct contact with the light emitting part of the light emitting element is provided by a scattering transparent resin. Thus, the light that does not become incident on the first optical system is scattered by the scattering transparent resin, so that part of the light is let to be incident on the second optical system and led to the light receiving part of the light receiving element.

Also, there is provided a method for manufacturing the optical distance measuring device including:

forming, by potting, the transparent resin that forms part of the second optical system; and

forming the light shielding resin by casting or transfer molding.

In this case, the second optical system forming the second optical path can be formed by linearly drawing the transparent resin, which can be achieved by moving a needle tip of a dispenser or the like while discharging the transparent resin of high viscosity through the needle tip of the dispenser. Further, the light shielding resin can be formed by casting or transfer molding after the potting.

In one embodiment of the invention, the light receiving part of the light receiving element is provided in plurality, some of the plurality of light receiving parts being optically coupled with the first optical system and the others of the light receiving parts being optically coupled with the second optical system, and

a wall which inhibits the transparent resin from spreading therebeyond in the potting process is provided between the light receiving parts optically coupled with the first optical system and the light receiving parts optically coupled with the second optical system.

In this embodiment, in the process of forming the transparent resin forming the second optical system by potting, the transparent resin potted to the light receiving part for the second optical path is blocked by the wall and thereby prevented from making direct contact with the light receiving part for the first optical path. Therefore, even when a small-sized light receiving element is used for the manufacture of a small-sized optical distance measuring device, the second optical system can be optically isolated from the first optical system with reliability.

In one embodiment of the invention, in the transparent resin that forms part of the second optical system,

both end portions of the transparent resin are in direct contact with the light emitting part of the light emitting element and the light receiving part of the light receiving element and serve as optical coupling parts optically coupled with the light emitting part and the light receiving part, respectively,

both end portions of a transparent passage defined by the two optical coupling parts are opposed to the light emitting part and the light receiving part, respectively, via the optical coupling parts, and

the transparent passage is surrounded on its periphery by the light shielding resin.

In this embodiment, the second optical system that forms the second optical path, along which light emitted from the light emitting element reaches the light receiving element, is made up of a transparent passage surrounded on its periphery by the light shielding resin, and optical coupling parts which are located on both sides of the transparent passage and which are in direct contact with the light emitting part of the light emitting element and the light receiving part of the light receiving element so as to be optically coupled with the light emitting part and the light receiving part. Then, both end portions of the transparent passage are opposed to the light emitting part and the light receiving part via the optical coupling parts. Therefore, light that has passed through the second optical path can be prevented from becoming incident on the end face of the light receiving element. Further, by the transparent passage being surrounded on its periphery by the light shielding resin, useless leakage light in the second optical path can be suppressed. Thus, the optical coupling efficiency can be enhanced.

In one embodiment of the invention, the transparent passage in the transparent resin has a semicircular-shaped cross-sectional configuration, and

the light shielding resin is formed by containing a light-reflective material.

In this embodiment, the cross-sectional configuration of the transparent passage is a semicircular shape, and the light shielding resin that surrounds the periphery of the transparent passage is formed by containing a light reflective material. Therefore, the resulting state is that a mirror is placed at the line part of the semicircular shape, which can be regarded as optically equivalent to that a transparent passage having a circular-shaped cross section is buried. Thus, it becomes practicable to reduce transmission loss of light as with optical fibers.

In one embodiment of the invention, the method for manufacturing the optical distance measuring device further includes:

forming the light shielding resin so that the light shielding resin has, at a surface thereof, a stepped recess a cross-sectional configuration-of which is a two-stepped structure over a range from a proximity of the light emitting element to a proximity of the light receiving element;

potting and curing the transparent resin within a first-step recess in the stepped recess provided at the surface of the light shielding resin; and

thereafter potting and curing the light shielding resin within a second-step recess in the stepped recess, whereby

the transparent passage surrounded on its periphery by the light shielding resin is formed.

In this case, the transparent resin is formed by potting within the first-step recess in the stepped recess provided at the surface of the light shielding resin, and the light shielding resin is formed by potting within the second-step recess. Therefore, the transparent passage can be easily buried in the light shielding resin by potting.

In one embodiment of the invention, the method for manufacturing the optical distance measuring device further includes:

forming the light shielding resin so that the light shielding resin has, at a surface thereof, a recess over a range from a proximity of the light emitting element to a proximity of the light receiving element;

potting and curing the transparent resin up to a less-than-full depth within the recess provided at the surface of the light shielding resin; and

thereafter placing, within a mold die, a substrate on which the light shielding resin and the transparent resin are formed, and injecting the light shielding resin onto the transparent resin within the recess, followed by transfer molding, whereby

the transparent passage surrounded on its periphery by the light shielding resin is formed.

In this case, the transparent resin is formed by potting up to a less-than-full depth within the recess provided at the surface of the light shielding resin, and further the light shielding resin is formed on the transparent resin by transfer molding. Therefore, as compared with the case where the light shielding resin is formed by potting within the recess, the transparent passage can be surrounded on its periphery by the light shielding resin having the absolutely same optical characteristics, making it possible to further reduce the transmission loss of light in the transparent passage.

In one embodiment of the invention, the method for manufacturing the optical distance measuring device further includes:

forming the light shielding resin so that the light shielding resin has, at a surface thereof, a recess over a range from a proximity of the light emitting element to a proximity of the light receiving element;

placing, within a first mold die, a substrate on which the light shielding resin is formed, and injecting the transparent resin up to a less-than-full depth within the recess provided at the surface of the light shielding resin, followed by transfer molding; and

placing, within a second mold die, the substrate with the transparent resin formed thereon, and injecting the light shielding resin onto the transparent resin within the recess, followed by transfer molding, whereby

the transparent passage surrounded on its periphery by the light shielding resin is formed.

In this case, the transparent resin is formed by transfer molding up to a less-than-full depth within the recess provided at the surface of the light shielding resin, and further the light shielding resin is formed on the transparent resin by transfer molding. Therefore, the transparent passage can be promptly buried in the light shielding resin by transfer molding. Further, the transparent passage can be surrounded on its periphery by the light shielding resin having the absolutely same optical characteristics, making it possible to further reduce the transmission loss of light in the transparent passage.

As apparent from the above description, the optical distance measuring device of the invention is so structured that the second optical system forming the second optical path, along which light emitted from the light emitting element reaches the light receiving element without being reflected by the measuring object, is formed by containing a transparent resin that is in direct contact with the light emitting part of the light emitting element and the light receiving part of the light receiving element. As a result of this, even if the length of the second optical path has increased with increasing temperature, the refractive index of the second optical path decreases, so that the optical path length, which is given by a product of the length of an optical path and the refractive index of the optical path, becomes generally constant. Accordingly, the optical path length of the second optical path is generally constant independently of temperature, so that a high distance measuring accuracy can be obtained even under environments of intense temperature changes.

Further, in the case where the light receiving part of the light receiving element is provided in plurality, and where some of the plurality of light receiving parts are optically coupled with the first optical system and the others of the light receiving parts are optically coupled with the second optical system, it becomes possible to reduce characteristic variations of the individual light receiving parts due to temperature, as compared with the case where light receiving parts optically coupled with the first optical system and light receiving parts optically coupled with the second optical system are provided in different light receiving elements. As a result, errors of resulting distance information due to temperature can be further reduced. Besides, as compared with the case where the light receiving element is used in plurality, the optical distance measuring device can be reduced in size to more extent.

Further, in the case where the second optical system forming the second optical path, along which light emitted from the light emitting element reaches the light receiving element without being reflected by the measuring object, is made up of a transparent passage surrounded on its periphery by the light shielding resin, and optical coupling parts which are located on both sides of the transparent passage and which are optically coupled with the light emitting part of the light emitting element and the light receiving part of the light receiving element, and where both end portions of the transparent passage are opposed to the light emitting part and the light receiving part via the optical coupling parts, light that has passed through the second optical path can be prevented from becoming incident on the end face of the light receiving element. Besides, by surrounding the transparent passage on its periphery by the light shielding resin, useless leakage light in the second optical path can be suppressed. Thus, the optical coupling efficiency can be enhanced.

As to the method for manufacturing the optical distance measuring device according to the invention, since the transparent resin forming the second optical system is formed by potting, the transparent resin can be formed linearly along the second optical path by moving a needle tip of a dispenser or the like while discharging the transparent resin of high viscosity through the needle tip of the dispenser. Further, since the light shielding resin is formed by casting or transfer molding, the light shielding resin can be formed after the potting.

Also, in the method for manufacturing the optical distance measuring device according to the invention, the transparent resin is formed by potting within the first-step recess in the stepped recess provided at the surface of the light shielding resin, and the light shielding resin is formed by potting within the second-step recess. Therefore, the transparent passage can be easily buried in the light shielding resin by potting.

Furthermore, in the case where the light shielding resin, which is to be formed on the transparent resin formed on the lower side within the recess provided at the surface of the light shielding resin, is formed by transfer molding, the transparent passage can be surrounded on its periphery by the light shielding resin having the absolutely same optical characteristics, so that the transmission loss of light in the transparent passage can be reduced to more extent, as compared with the case where the light shielding resin is formed by potting within the recess.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a plan view of an optical distance measuring device according to the present invention;

FIG. 2 is a side view of the optical distance measuring device shown in FIG. 1;

FIG. 3 is a view showing a state in which the shielding case has been removed from FIG. 1;

FIG. 4 is a view showing a state in which the shielding case has been removed from FIG. 2;

FIG. 5 is a view showing a state in which the light shielding resin in FIG. 3 is shown as transparent;

FIG. 6 is a sectional view taken along the line A-A′ of FIG. 5;

FIG. 7 is a view showing a positional relationship between a measuring object and an optical distance measuring device;

FIGS. 8A and 8B are views for explaining a manufacturing method for the optical distance measuring device shown in FIG. 1;

FIGS. 9A and 9B are views for explaining the manufacturing method subsequent to FIGS. 8A and 8B;

FIG. 10 is a view for explaining the manufacturing method subsequent to FIGS. 9A and 9B;

FIGS. 11A and 11B are views for explaining the manufacturing method subsequent to FIG. 10;

FIG. 12 is a view for explaining the manufacturing method subsequent to FIGS. 11A and 11B;

FIGS. 13A and 13B are views showing a state in which a first lens and a second lens are formed on a printed wiring board;

FIGS. 14A and 14B are views showing a state in which a wall is formed between a first light receiving part and a second light receiving part on the light receiving element;,

FIG. 15 is a plan view of an optical distance measuring device different from FIG. 1;

FIG. 16 is a sectional view taken along the line G-G′ of FIG. 15;

FIG. 17 is a view showing a state in which the shielding case has been removed from an optical distance measuring device other than that of FIG. 1 and in which the light shielding resin is shown as transparent;

FIG. 18 is a sectional view taken along the line H-H′ of FIG. 17;

FIG. 19 is a view showing a positional relationship between a measuring object and an optical distance measuring device shown in FIG. 17;

FIGS. 20A and 20B are views for explaining a manufacturing method for the optical distance measuring device shown in FIG. 17;

FIG. 21 is a view for explaining the manufacturing method subsequent to FIGS. 20A and 20B;

FIGS. 22A and 22B are views showing a state in which a plate-shaped light shielding resin is formed on a printed wiring board;

FIGS. 23A and 23B are sectional views taken along the line K-K′ of FIGS. 22A and 22B;

FIGS. 24A and 24B are views for explaining the manufacturing method subsequent to FIG. 21;

FIGS. 25A and 25B are views for explaining the manufacturing method subsequent to FIGS. 24A and 24B;

FIGS. 26A and 26B are sectional views taken along the line N-N′ of FIGS. 25A and 25B;

FIG. 27 is a view for explaining the manufacturing method subsequent to FIGS. 25A and 25B;

FIG. 28 is a view for explaining the manufacturing method subsequent to FIGS. 24A and 24B which are different from FIGS. 25A and 25B; and

FIGS. 29A and 29B are views showing a state in which a transparent passage is buried in the plate-shaped light shielding resin by transfer molding.

### DETAILED DESCRIPTION OF THE INVENTION

Hereinbelow, the present invention will be described in detail by way of embodiments thereof illustrated in the accompanying drawings.

### First Embodiment

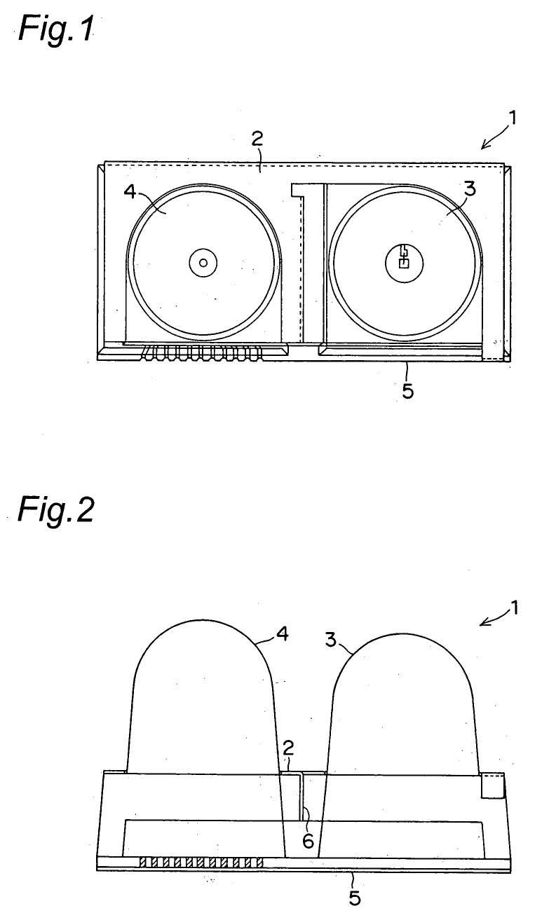

FIG. 1 is a plan view of an optical distance measuring device 1 according to this embodiment. FIG. 2 is a side view of the optical distance measuring device 1 shown in FIG. 1. This optical distance measuring device 1, which uses a first optical path along which light emitted from a light emitting element is reflected by a measuring object and detected by a light receiving element and a second optical path along which light emitted from the light emitting element is detected by the light receiving element without being reflected by the measuring object, is a small-sized optical distance measuring device suitable particularly for use in personal robots that are required to detect obstacles, noncontact switches having no mechanical contacts, noncontact control devices or other electronic equipment.

The optical distance measuring device 1 is so constructed as to be shielded by a shielding case 2 so that external electric noise does not enter inside. The shielding case 2 is bent at a place between a first lens 3 for a light emitting part and a second lens 4 for a light receiving part so as to be directed toward a PWB (Printed Wiring Board) 5 and to serve as a partition 6 between light emission and light reception side. This partition 6 intercepts light that passes directly between the two lenses 3, 4.

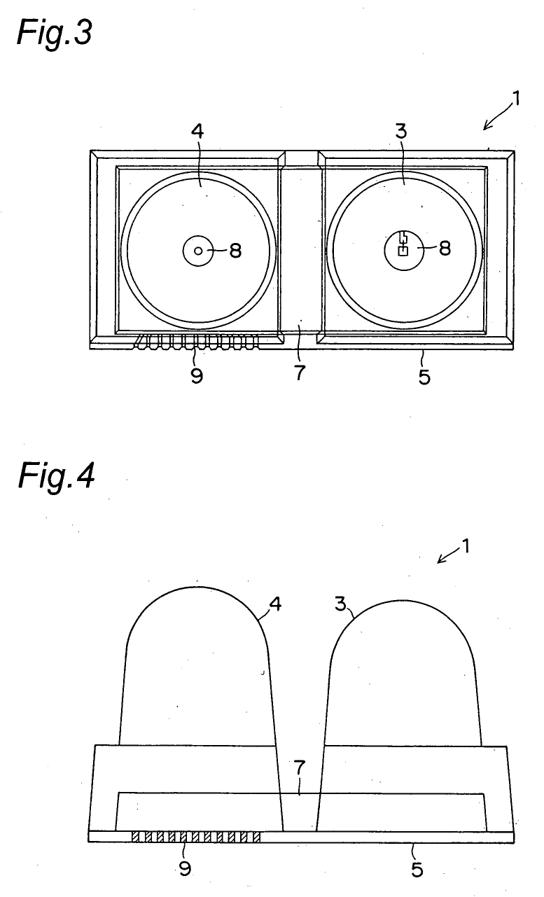

FIG. 3 is a view showing a state in which the shielding case 2 has been removed from FIG. 1, and FIG. 4 is a view showing a state in which the shielding case 2 has been removed from FIG. 2. FIGS. 3 and 4 show a state in which a light shielding resin 7, which is, e.g., of black color, can be seen through a transparent resin that forms the first lens 3 and the second lens 4 and the like. It is noted that a plurality of electrodes 9 are arrayed on one side face of the PWB 5, so that supply of circuit driving power as well as extraction of distance information to the outside are implemented from those electrodes 9.

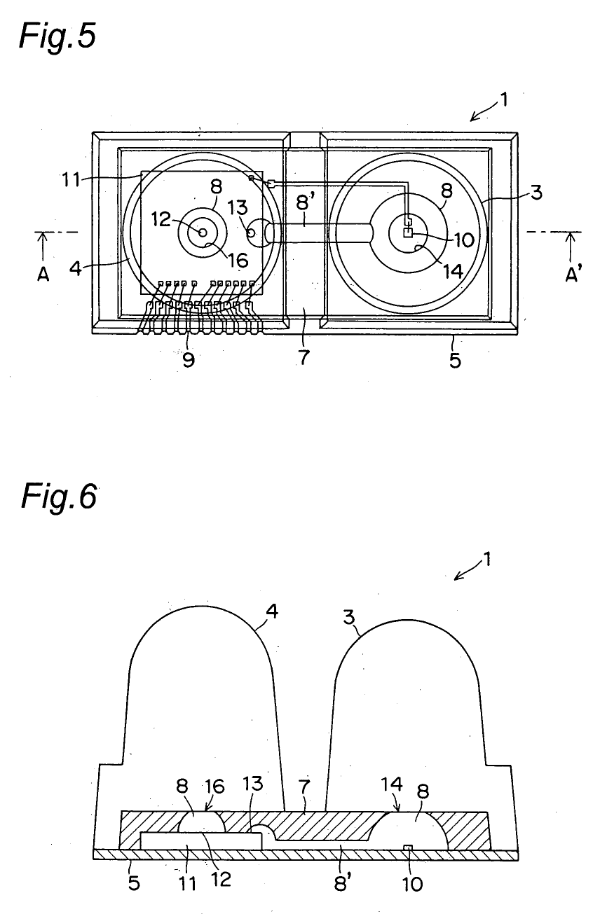

FIG. 5 shows a case in which the light shielding resin 7 in FIG. 3 is shown as transparent for explanation's sake. FIG. 6 is a sectional view taken along the line A-A′ of FIG. 5. The optical distance measuring device 1 is so structured that a light emitting element (LED, i.e. light emitting diode) 10 and a light receiving element (PD, i.e. photodiode) 11 die-bonded onto the PWB 5 are overlaid with a transparent resin 8, 8′ made of silicone resin or the like, further overlaid thereon with the light shielding resin 7 made of epoxy resin or the like, and furthermore overlaid thereon with a transparent resin such as epoxy resin that forms the first and second lenses.

In the light receiving element 11, two light receiving parts composed of a first light receiving part 12 and a second light receiving part 13 are formed. On the PWB 5, the light emitting element 10 and the second light receiving part 13 are directly connected to each other by the transparent resin 8, 8′.

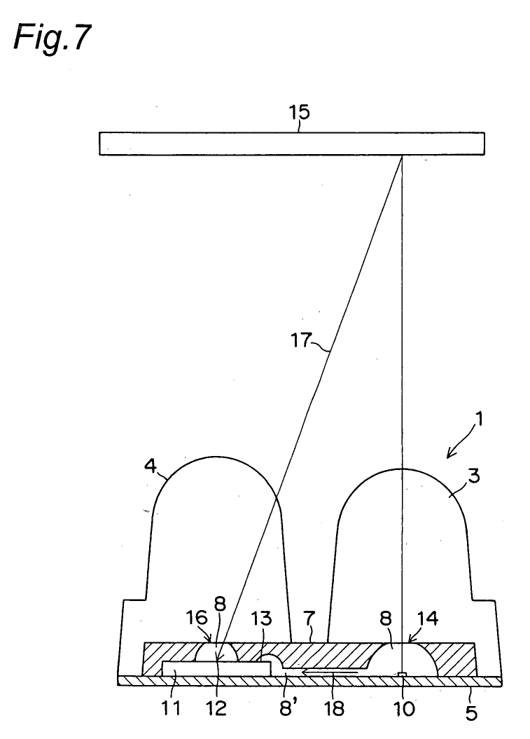

FIG. 7 shows the positional relationship between a measuring object 15 and the optical distance measuring device 1. As light emitted from the light emitting element 10 has a directivity of 60° in half angle at half maximum, light emitted toward the front passes through the transparent resin 8 such as silicone resin, through a window 14 of the light shielding resin 7, and through the first lens 3 formed of a transparent resin such as epoxy resin, so as to form generally parallel rays of light, being incident on the measuring object 15. Then, the light incident on the measuring object 15 is reflected radially by the measuring object 15, and part of the reflected light directed toward the optical distance measuring device 1 passes through the second lens 4 formed of a transparent resin such as epoxy resin, through a window 16 of the light shielding resin 7, through the transparent resin 8 such as silicone resin, so as to be incident on the first light receiving part 12 of the light receiving element 11. Hereinafter, this optical path will be referred to as first optical path 17.

Meanwhile, out of the light emitted from the light emitting element 10, for example, part of the light having 30° or more directivity angles is inhibited from passing through the window 14 of the light shielding resin 7 and is reflected by the light shielding resin 7. Then, the light passes through the transparent resin 8, 8′ such as silicone resin, which directly connects the light emitting element 10 and the light receiving element 11 to each other, so as to be incident on the other second light receiving part 13 optically isolated from the first light receiving part 12 that receives light derived from the first optical path 17. Hereinafter, this optical path will be referred to as second optical path 18.

In this way, the rays of light incident on different light receiving parts, i.e. the first light receiving part 12 and the second light receiving part 13, in the light receiving element 11 are converted into electric currents and processed by an electronic circuit (not shown) formed monolithic in the light receiving element 11, by which distance information ranging to the measuring object 15 is obtained. In this case, variations in response speed of the light emitting element 10, variations in response speed of the light receiving element 11 and characteristic changes of the light emitting element 10 and the light receiving element 11 caused by environmental (primarily, temperature) or other influences are corrected by the electronic circuit by referencing the length of the second optical path 18.

Accordingly, in this embodiment, the first optical system is made up of the transparent resin 8, the window 14 of the light shielding resin 7, the first lens 3, the second lens 4, the window 16 of the light shielding resin 7 and the transparent resin 8. Also, the second optical system is made up of the transparent resin 8, the light shielding resin 7 and the transparent resin 8′.

As described above, in the optical distance measuring device 1, the second optical path 18 is formed by the transparent resin 8, 8′ formed in a region where the light emitting element 10 and the second light receiving part 13 are connected to each other on the PWB 5. Generally, an optical path length is given by a product of a length of an optical path and a refractive index of the optical path. In the case of a transparent resin, as the temperature increases, the length of the optical path increases while the refractive index decreases, so that the optical path length itself holds generally constant as a property. Therefore, the second optical path 18, which is formed in the transparent resin 8, 8′ that makes direct contact with the light emitting element 10 and the second light receiving part 13 of the light receiving element 11, can keep a generally constant length independently of temperature.

Also, the first light receiving part 12 for the first optical path 17 and the second light receiving part 13 for the second optical path 18 are formed in one identical light receiving element 11. Therefore, as compared with the case where the first light receiving part and the second light receiving part are formed in different light receiving elements, characteristic variations of the first light receiving part 12 and the second light receiving part 13 due to temperature can be reduced. As a result, it becomes practicable to reduce errors in distance information due to characteristic variations caused by temperature between the first light receiving part 12 and the second light receiving part 13. Further, as compared with the case where a plurality of light receiving elements are employed, it becomes practicable to downsize the optical distance measuring device 1.

The second optical path 18 is optically isolated from the first optical path 17 by the light shielding resin 7. Thus, there is no crosstalk between the first optical path 17 and the second optical path 18. Accordingly, there is no need for providing any optical path changing switch or the like.

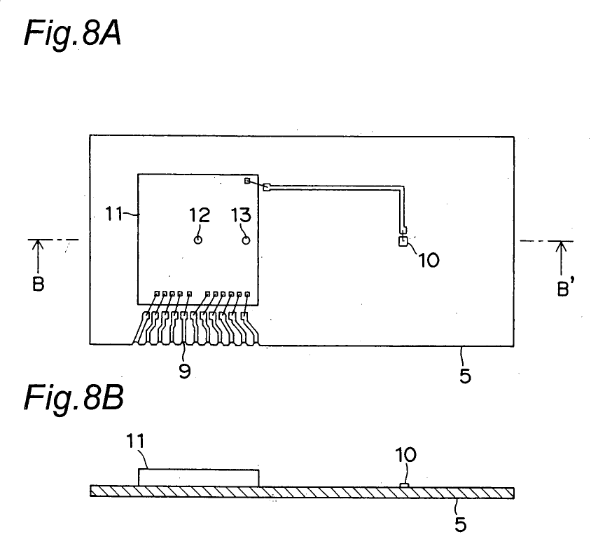

Now, a manufacturing method for the optical distance measuring device 1 is explained below with reference to FIGS. 8 to 14.

FIG. 8A is a plan view of the PWB 5, and FIG. 8B is a sectional view taken along the line B-B′ of FIG. 8A. As shown in FIGS. 8A and 8B, first, semiconductor chips of a light emitting element 10, a light receiving element 11 and the like are die-bonded to the surface of a PWB 5 by silver paste or other electrically conductive adhesive. Subsequently, pad portions on the light emitting element 10 and the light receiving element 11 and pad portions on the PWB 5 are wire-bonded by gold wires or the like so as to be electrically connected to each other.

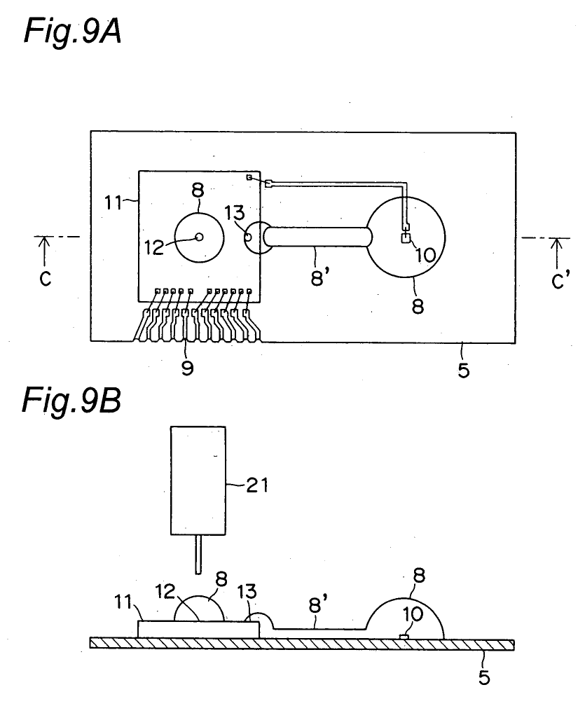

Next, as shown in FIGS. 9A and 9B, the transparent resin 8, 8′ such as silicone resin is potted to a specified position by a dispenser 21. In this process, the transparent resin 8′ can be formed linearly along the second optical path 18 by moving a needle tip of the dispenser 21 while discharging the transparent resin 8′ of high viscosity through the needle tip of the dispenser 21. In order to prevent the potted transparent resin 8, 8′ from spreading from the specified position due to gravity or vibrations, it is appropriate that with the use of an ultraviolet curable transparent resin as the transparent resin 8, 8′, the transparent resin 8, 8′, after potted, is half cured by irradiation of ultraviolet rays and thereafter finally cured by an oven. The application amount of potting resin is controlled by the dispenser 21 so that the resin is applied higher to portions that form the windows 14, 16 of the light shielding resin 7 in subsequent steps. It is noted that FIG. 9B is a sectional view taken along the line C-C′ of FIG. 9A.

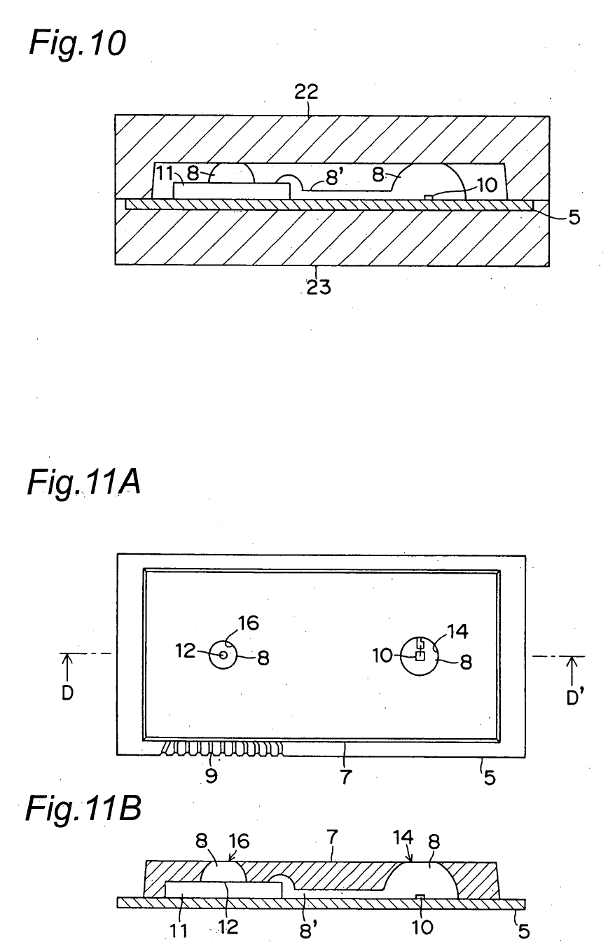

Next, the light shielding resin 7 is formed on the transparent resin 8, 8′. FIG. 10 is a longitudinal sectional view showing a state in which the PWB 5 is placed within mold dies 22, 23 for molding of the light shielding resin 7. In this state, a portion of the transparent resin 8 connecting to the first optical path 17 is crushed by the mold die 22 into a planar shape, by which portions to form the windows 14, 16 later are formed. Then, a light shielding resin in which epoxy resin is mixed with a light-absorbing additive is injected into a space defined by the PWB 5 and the mold die 22, and subjected to transfer molding, by which the plate-shaped light shielding resin 7 is obtained. It is noted that although transfer molding is used in this embodiment, casting may also appropriately be used.

FIGS. 11A and 11B show a state in which the plate-shaped light shielding resin 7 is formed on the PWB 5. Windows 14, 16 are formed in the light shielding resin 7 above the light emitting element 10 and the light receiving element 11. It is noted that FIG. 11B is a sectional view taken along the line D-D′ of FIG. 11A.

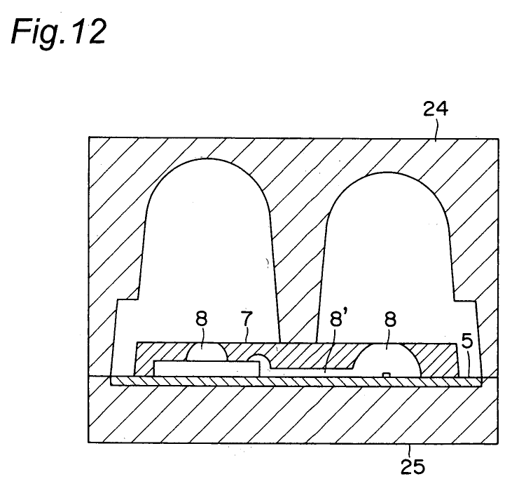

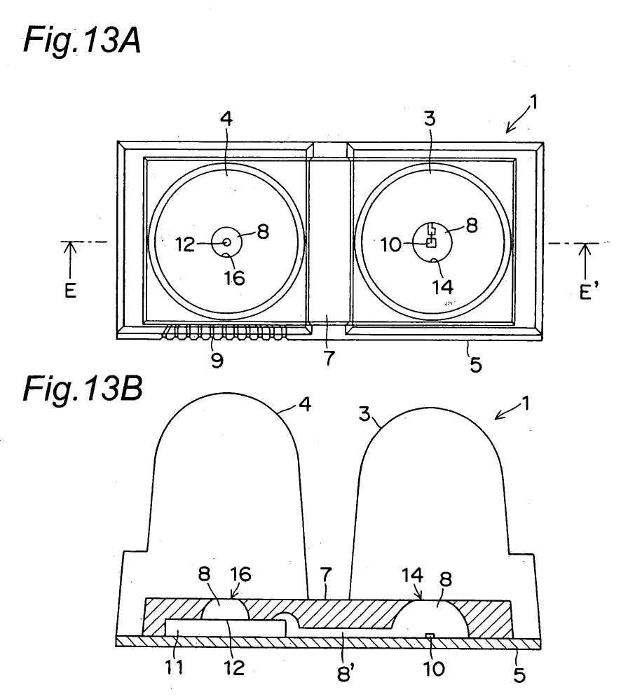

FIG. 12 is a longitudinal sectional view showing a state in which the PWB 5 is placed within mold dies 24, 25 for formation of the first, second lenses 3, 4. A transparent resin such as epoxy resin is injected into a space defined by the PWB 5 and the mold die 24 and subjected to transfer molding, by which the first, second lenses 3, 4 are formed. FIGS. 13A and 13B show a state in which the first lens 3 and the second lens 4 are formed on the PWB 5 by the transparent resin. In addition, FIG. 13B is a sectional view taken along the line E-E′ of FIG. 13A.

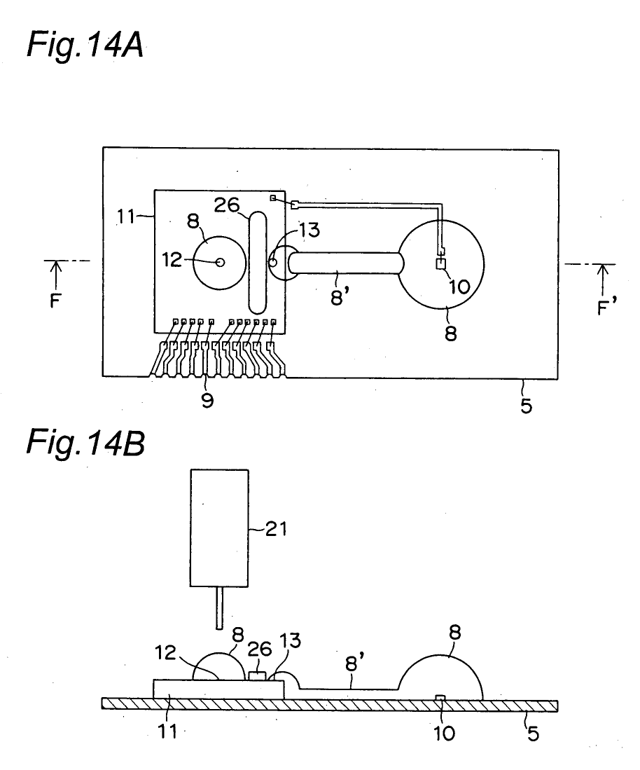

In this connection, as the light receiving element 11 becomes smaller in size, the distance between the first light receiving part 12 and the second light receiving part 13 becomes shorter inevitably. In the potting process shown in FIG. 9, there arises a likelihood that both the first light receiving part 12 connecting to the first optical path 17 and the second light receiving part 13 connecting to the second optical path 18 may be covered with the same transparent resin. In such a case, as shown in FIGS. 14A and 14B, a wall 26 for blocking the potted transparent resin 8, 8′ is formed between the first light receiving part 12 and the second light receiving part 13 on the light receiving element 11. This wall 26 is formed by screen printing or the like while the PWB 5 is in a wafer state. As a result of the formation of such a wall 26, the potted transparent resin 8, 8′ is blocked so that the first light receiving part 12 and the second light receiving part 13 are prevented from being both covered with the same transparent resin 8 or same transparent resin 8′. In addition, whereas the technique for forming the wall 26 is already known as a technique for mounting a glass plate on a CCD (Charge Coupled Device) with a wall interposed therebetween, this embodiment is characterized in that the technique is employed as a solution to the problem that both the first light receiving part 12 and the second light receiving part 13 are covered with the same transparent resin 8 or same transparent resin 8′.

When the shielding case 2 in FIG. 1 is mounted on the PWB 5 obtained in FIGS. 13A and 13B, the optical distance measuring device 1 is completed.

In the above description, in conjunction with the manufacturing method for the optical distance measuring device 1 shown in FIGS. 8 to 14, figures in which one optical distance measuring device 1 is formed on one PWB 5 are given, but those are intended for explanation's sake. Actually, a plurality of optical distance measuring devices 1 are formed in a lattice shape on the PWB 5, and the PWB 5 obtained in FIGS. 13A and 13B is cut out into individual optical distance measuring devices 1 by dicing.

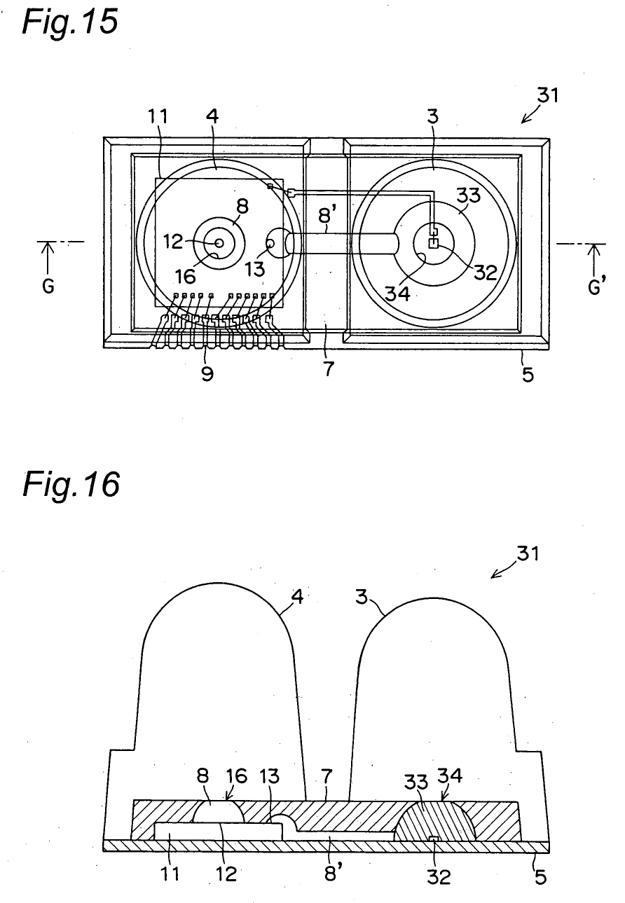

FIGS. 15 and 16 show an optical distance measuring device 31 in which a VCSEL (Vertical Cavity Surface Emitting Laser) is used as the light emitting element. FIGS. 15 and 16, like FIGS. 5 and 6, show a state in which the light shielding resin 7 is shown as transparent for explanation's sake. FIG. 16 is a sectional view taken along the line G-G′ of FIG. 15. In FIGS. 15 and 16, the same component members as in the optical distance measuring device 1, which employs an LED as the light emitting element, are designated by the same reference numerals.

The manufacturing method for the optical distance measuring device 31 differs from that of the case where an LED is used, in that a scattering transparent resin 33 is potted on a VCSEL 32 in the potting process shown in FIG. 9.

In the optical distance measuring device 31 with the use of the VCSEL 32, as light emitted from the VCSEL 32 has a directivity of 15° in half angle at half maximum, light emitted toward the front passes through the scattering transparent resin 33, in which a scatterer is mixed into silicone resin, so as to be scattered. The light scattered toward the front passes through a window 34 of the light shielding resin 7, and through the first lens 3 formed of a transparent resin such as epoxy resin, so as to form generally parallel rays of light, being incident on a measuring object (not shown). Then, the light incident on the measuring object is reflected radially by the measuring object, and part of the reflected light directed toward the optical distance measuring device 31 passes through the second lens 4 formed of a transparent resin such as epoxy resin, through a window 16 of the light shielding resin 7, through the transparent resin 8 such as silicone resin, so as to be incident on the first light receiving part 12 of the light receiving element 11. This is all of the description on the first optical path.

Meanwhile, out of the light emitted from the VCSEL 32 and scattered, for example, part of the light having 30° or more directivity angles is inhibited from passing through the window 34 of the light shielding resin 7 and is reflected by the light shielding resin 7. Then, the light passes through the transparent resin 8′ such as silicone resin, which directly connects the VCSEL 32 and the light receiving element 11 to each other, so as to be incident on the other second light receiving part 13 which is not optically connected to the first light receiving part 12 that receives light derived from the first optical path 17. This is all of the description on the second optical path.

As described above, in the manufacturing method for the optical distance measuring device 31, the transparent resin 8, 8′ of silicone resin or the like is formed by potting, and the light shielding resin 7 is formed on the transparent resin 8, 8′ by transfer molding. Therefore, the transparent resin 8′ to form the second optical path 18 can be formed linearly along the second optical path 18 by moving the needle tip of the dispenser 21 while discharging the transparent resin 8′ of high viscosity through the needle tip of the dispenser 21. Further, since the light shielding resin 7 is formed by transfer molding, a portion of the transparent resin 8 that connects to the first optical path 17 can be crushed by the mold die 22 into a planar shape, so that portions that form the windows 14, 16 in subsequent steps can be easily formed.

### Second Embodiment

In the optical distance measuring device 1 of the first embodiment, since the second optical path 18 connects to an end face of the light receiving element 11 on one side closer to the second light receiving part 13 as shown in FIG. 7, there are some cases where the S/N ratio value is deteriorated by optical noise caused by the light which is refracted by the end face and is incident on the light receiving element 11, resulting in an increase in measurement errors. Also, since most part of light that has passed along the second optical path 18 goes incident on the end face of the light receiving element 11, the optical coupling efficiency of the second optical path 18 results in a lower one. Accordingly, this embodiment relates to an optical distance measuring device in which the optical coupling efficiency of, in particular, the second optical path is even higher and which is capable of achieving a high distance measuring accuracy even under environments in which intense temperature changes are involved.

Hereinbelow, an optical distance measuring device of this embodiment will be described in detail primarily about its differences from the first embodiment.

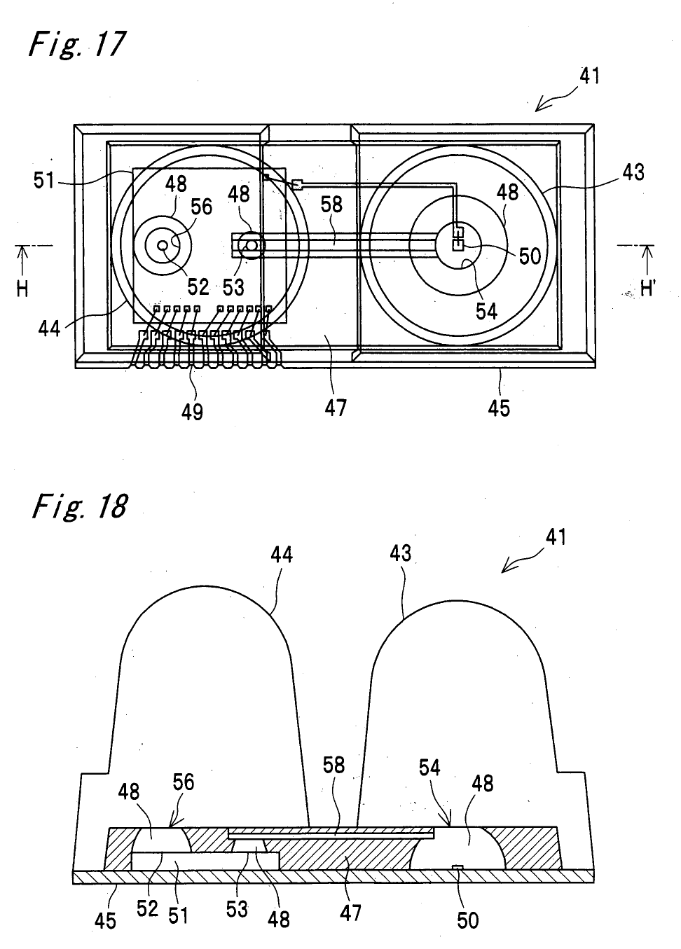

FIG. 17 shows a case in which the shielding case has been removed from the optical distance measuring device 41 of this embodiment and in which the light shielding resin is shown as transparent for explanation's sake. FIG. 18 is a sectional view taken along the line H-H′ of FIG. 17. The optical distance measuring device 41 is so structured that a light emitting element 50 and a light receiving element 51 die-bonded on a PWB 45 are overlaid with a transparent resin 48 such as silicone resin, further overlaid thereon with a light shielding resin 47 formed of epoxy resin or the like, and further overlaid thereon with a transparent resin such as epoxy resin that forms a first lens 43 and a second lens 44. It is noted that reference numeral 49 denotes electrodes for implementing supply of circuit driving power as well as extraction of distance information to the outside.

In the light receiving element 51, two light receiving parts composed of a first light receiving part 52 and a second light receiving part 53 are formed and each covered with the transparent resin 48. Between the light emitting element 50 and the light receiving element 51 in the light shielding resin 47, a transparent passage 58 by which a transparent resin 48 on the light emitting element 50 side and another transparent resin 48 covering the second light receiving part 53 on the light receiving element 51 side are communicated with each other is formed from a transparent resin such as silicone resin.

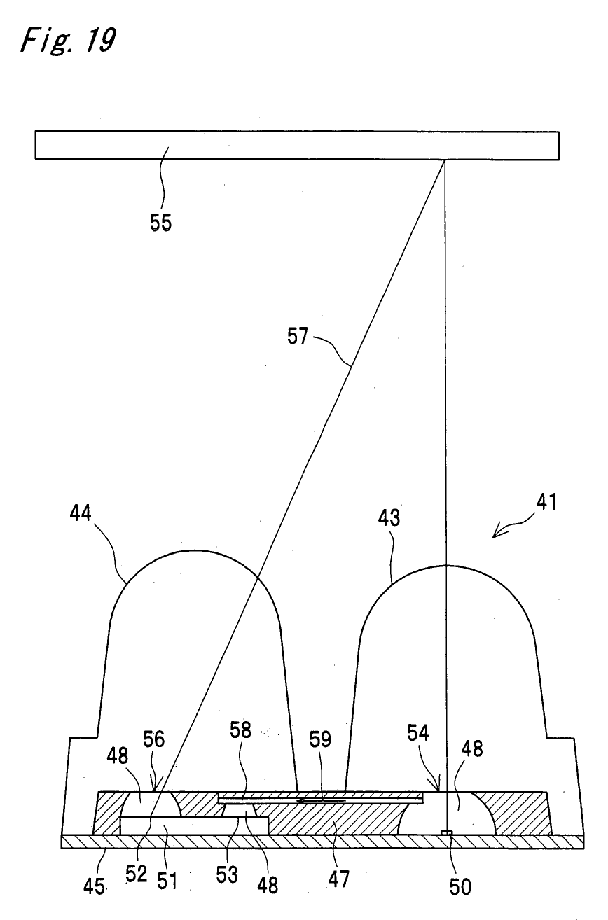

FIG. 19 shows a positional relationship between a measuring object 55 and the optical distance measuring device 41. As light emitted from the light emitting element 50 has a directivity of 60° in half angle at half maximum, light emitted toward the front passes through the transparent resin 48 such as silicone resin, through a window 54 of the light shielding resin 47, and through the first lens 43 formed of a transparent resin such as epoxy resin, so as to form generally parallel rays of light, being incident on the measuring object 55. Then, the light incident on the measuring object 55 is reflected radially by the measuring object 55, and part of the reflected light directed toward the optical distance measuring device 41 passes through the second lens 44 formed of a transparent resin such as epoxy resin, through a window 56 of the light shielding resin 47, and through the transparent resin 48 such as silicone resin, so as to be incident on the first light receiving part 52 of the light receiving element 51. Hereinafter, this optical path will be referred to as first optical path 57.

Meanwhile, out of the light emitted from the light emitting element 50, for example, part of the light having 30° or more directivity angles is inhibited from passing through the window 54 of the light shielding resin 47 and is reflected by the light shielding resin 47. Then, the light passes through the transparent passage 58, which is formed of a transparent resin such as silicone resin in the light shielding resin 47 to directly connect the light emitting element 50 and the light receiving element 51 to each other, is incident on the other second light receiving part 53 optically isolated from the first light receiving part 52 that receives light derived from the first optical path 57. Hereinafter, this optical path will be referred to as second optical path 59. That is, in this embodiment, the transparent resin 48 on the light emitting element 50 side and the transparent resin 48 covering the second light receiving part 53 on the light receiving element 51 side constitute optical coupling parts.

In this way, the rays of light incident on different light receiving parts, i.e. the first light receiving part 52 and the second light receiving part 53, in the light receiving element 51 are converted into electric currents and processed by an electronic circuit (not shown) formed monolithic in the light receiving element 51, by which distance information ranging to the measuring object 55 is obtained. In this case, variations in response speed of the light emitting element 50, variations in response speed of the light receiving element 51 and characteristic changes of the light emitting element 50 and the light receiving element 51 caused by environmental (primarily, temperature) or other influences are corrected by the electronic circuit by referencing the length of the second optical path 59.

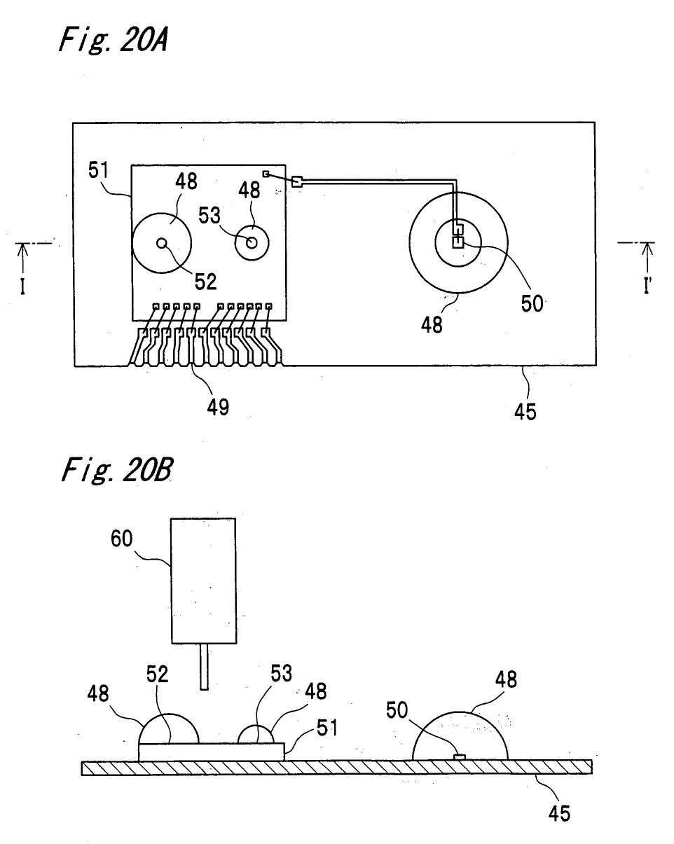

Now, a manufacturing method for the optical distance measuring device 41 is explained below with reference to FIGS. 20A and 20B.

In FIG. 20, FIG. 20A is a plan view of the PWB 45, and FIG. 20B is a sectional view taken along the line I-I′ of FIG. 20A. As shown in FIGS. 20A and 20B, first, semiconductor chips of a light emitting element 50, a light receiving element 51 and the like are die-bonded to the surface of the PWB 45 by silver paste or other electrically conductive adhesive. Subsequently, pad portions on the light emitting element 50 and the light receiving element 51 and pad portions on the PWB 45 are wire-bonded by gold wires or the like so as to be electrically connected to each other.

Next, as shown in FIG. 20B, the transparent resin 48 such as silicone resin is potted to a specified position by a dispenser 60. In order to prevent the potted. transparent resin 48 from spreading from the specified position due to gravity or vibrations, it is appropriate that with the use of an ultraviolet curable transparent resin as the transparent resin 48, the transparent resin 48, after potted, is half cured by irradiation of ultraviolet rays and thereafter finally cured by an oven. The application amount of potting resin is controlled by the dispenser 60 so that the resin is applied higher to portions that form the windows 54, 56 of the light shielding resin 47 in subsequent steps.

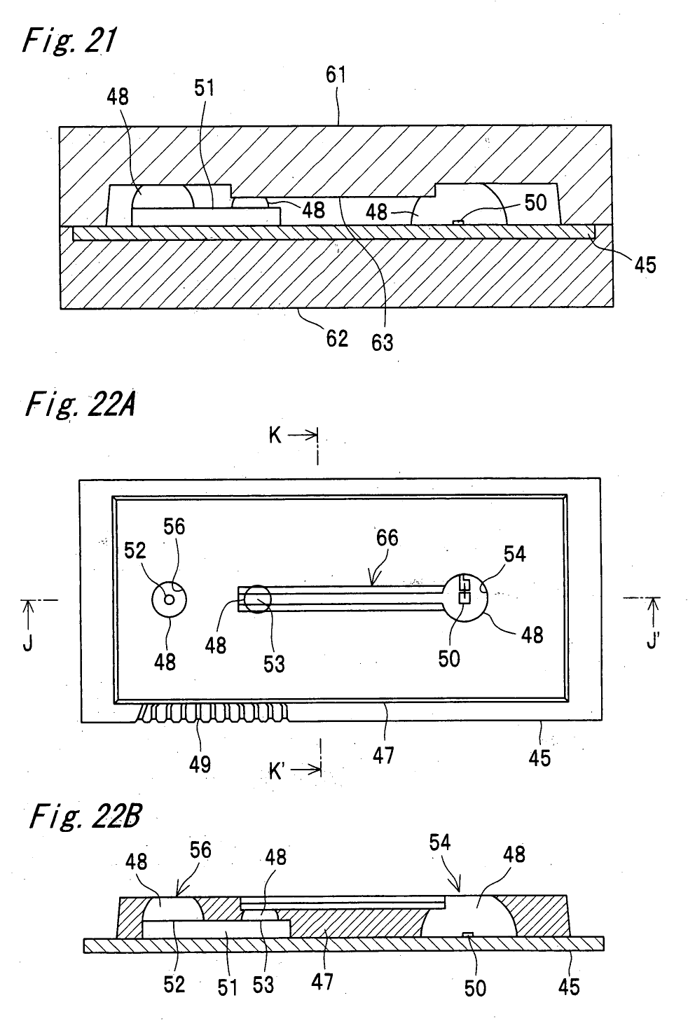

Next, the light shielding resin 47 is formed on the transparent resin 48. FIG. 21 is a longitudinal sectional view showing a state in which the PWB 45 is placed within mold dies 61, 62 for molding of the light shielding resin 47. In this state, a portion of the transparent resin 48 connecting to the first optical path 57 is crushed by the mold die 61 into a planar shape, by which portions to form the windows 54, 56 later are formed. In the mold die 61, a long, narrow protrusion 63 is formed so as to range from a place of the transparent resin 48 on the light emitting element 50 side to a place of the transparent resin 48 on the second light receiving part 53 on the light receiving element 51 side. Then, a light shielding resin in which epoxy resin is mixed with a reflective additive such as silica is injected into a space defined by the PWB 45 and the mold die 61, and subjected to transfer molding, by which the plate-shaped light shielding resin 47 is obtained.

FIGS. 22A and 22B show a state in which the plate-shaped light shielding resin 47 is formed on the PWB 45. Windows 54, 56 are formed in the light shielding resin 47 above the light emitting element 50 and the light receiving element 51. Further, at an upper surface of the light shielding resin 47, a stepped recess 66 is formed to connect the transparent resin 48 on the light emitting element 50 side and the transparent resin 48 on the second light receiving part 53 on the light receiving element 51 side to each other by the protrusion 63 of the mold die 61. It is noted that FIG. 22B is a sectional view taken along the line J-J′ of FIG. 22A.

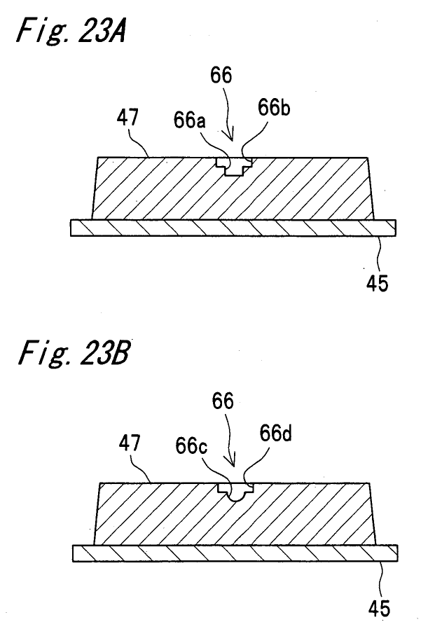

FIGS. 23A and 23B are a sectional view taken along the line K-K′ of FIG. 22A, showing a cross-sectional configuration of the stepped recess 66 formed at the upper surface of the light shielding resin 47. In the case of FIG. 23A, a first-step recess 66a located at the lower step in the stepped recess 66, as well as a second-step recess 66b located at the upper step, both have a rectangular-shaped cross section. In contrast to this, in the case of FIG. 23B, a first-step recess 66c in the stepped recess 66 has a semicircular cross section, and a second-step recess 66d has a rectangular-shaped cross section.

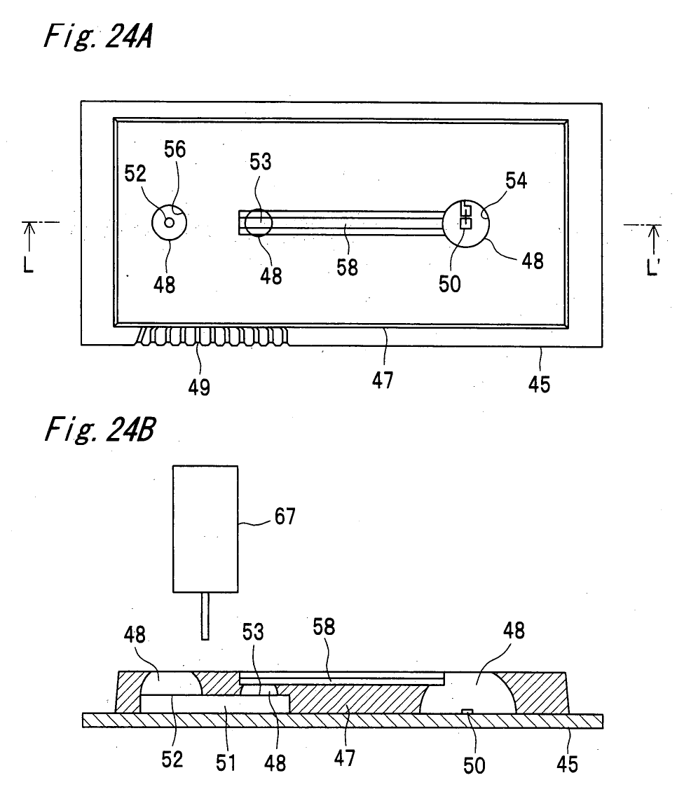

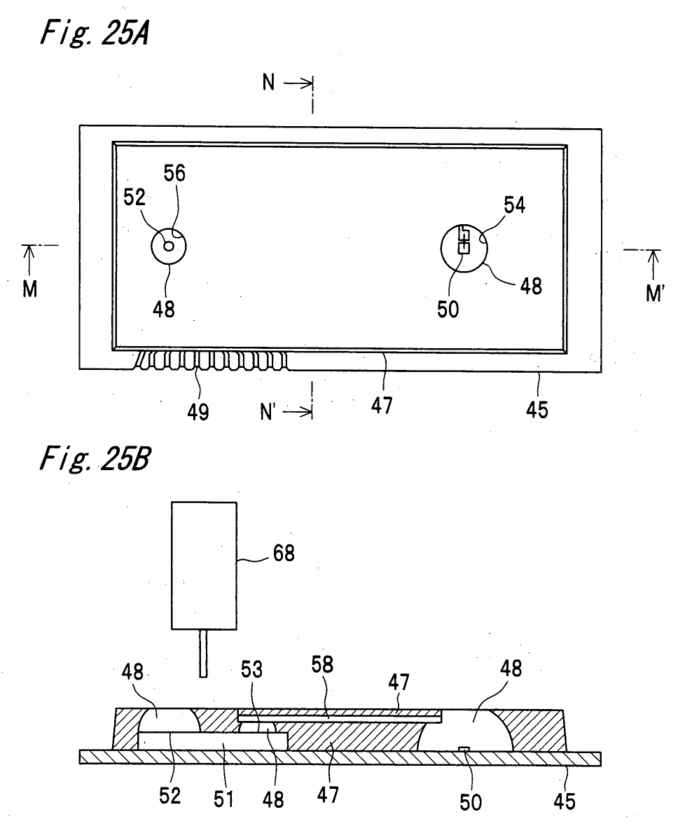

Next, as shown in FIGS. 24A, 24B, 25A and 25B, a transparent passage 58 is formed at the stepped recess 66 provided at the upper surface of the light shielding resin 47. It is noted that FIGS. 24B and 25B are a sectional view taken along the line L-L′ of FIG. 24A and a sectional view taken along the line M-M′ of FIG. 25A, respectively.

First, as shown in FIG. 24B, a transparent resin such as silicone resin is potted into the first-step recess 66a in FIG. 23A or the first-step recess 66c in FIG. 23B by a dispenser 67. Thereafter, the transparent resin is cured by heat in an unshown oven, by which the transparent passage 58 is formed. In this case also, in order to prevent the potted transparent resin from spreading, an ultraviolet curable transparent resin may be used as the transparent resin. In that case, the ultraviolet curable transparent resin is cured by irradiation of ultraviolet rays.

Next, as shown in FIG. 25B, a light shielding resin in which epoxy resin is mixed with a reflective additive such as silica is potted by the dispenser 68 into the second-step recess 66b in FIG. 23A or the second-step recess 66d in FIG. 23B, i.e., onto the transparent passage 58. Thereafter, the light shielding resin is cured by heat in an unshown oven, by which the transparent passage 58 is buried in the plate-shaped light shielding resin 47. In this case also, in order to prevent the potted light shielding resin from spreading, an ultraviolet-curable light shielding resin may be used. In that case, the ultraviolet-curable light shielding resin is cured by irradiation of ultraviolet rays.

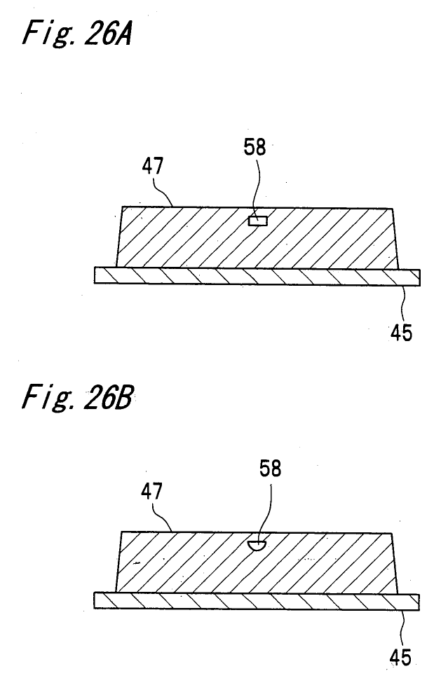

FIGS. 26A and 26B are sectional views taken along the line N-N′ of FIG. 25A, showing a cross-sectional configuration of the transparent passage 58 buried in the light shielding resin 47. FIG. 26A is a sectional view in a case where the transparent passage 58 is formed at the stepped recess 66 having a cross-sectional configuration shown in FIG. 23A, where the transparent passage 58 has a rectangular-shaped cross section. FIG. 26B is a sectional view in a case where the transparent passage 58 is formed at the stepped recess 66 having a cross-sectional configuration shown in FIG. 23B, where the transparent passage 58 has a semicircular-shaped cross section. In either case, a second optical path 59 implemented by the transparent passage 58 is surrounded by the light shielding resin 47.

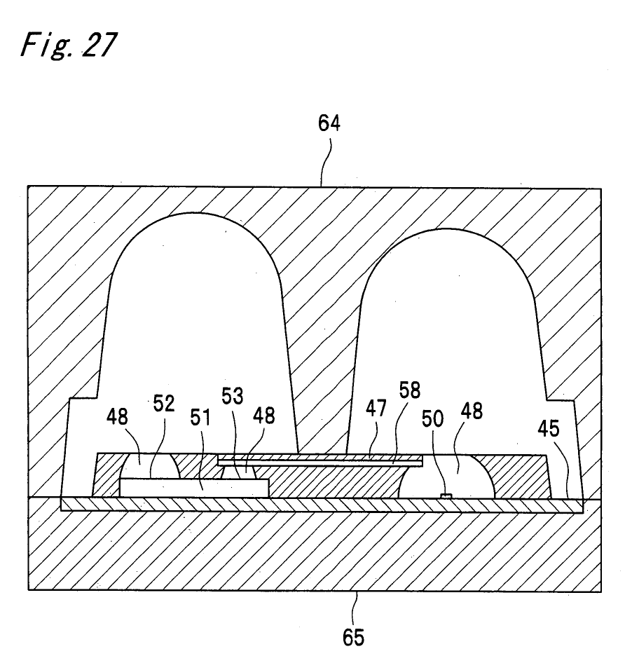

FIG. 27 is a longitudinal sectional view showing a state in which the PWB 45 is placed within mold dies 64, 65 for molding of the first, second lenses 43, 44. A transparent resin such as epoxy resin is injected into a space defined by the PWB 45 and the mold die 64 and subjected to transfer molding, by which the first, second lenses 43, 44 are formed.

As shown above, in this embodiment, the second optical path 59, along which light emitted from the light emitting element 50 becomes incident on the second light receiving part 53 in the light receiving element 51, is formed by the transparent passage 58 that is buried in the light shielding resin 47 and that directly connects the transparent resin 48 on the light emitting element 50 side and the transparent resin 48 covering the second light receiving part 53 on the light receiving element 51 side to each other. Accordingly, light that has passed through the second optical path 59 can be prevented from being incident on one end face of the light receiving element 51 on the second light receiving part 53 side. Further, one outgoing surface of the transparent passage 58 on the light emitting element 50 side can be made to confront the second light receiving part 53 of the light receiving element 51 via the transparent resin 48 serving as the optical coupling part. Thus, unnecessary leakage light in the second optical path 59 can be suppressed so that the optical coupling efficiency can be enhanced.

Under the conditions that the cross-sectional configuration of the transparent passage 58 is a semicircular shape convex toward the PWB 45 as shown in FIG. 26B and that the light shielding resin having a silica or other reflective additive mixed therein is buried on the upper side of the transparent passage 58, the resulting state is that a mirror is placed at the line part of the semicircular shape, which can be regarded as optically equivalent to that a transparent passage having a circular-shaped cross section is buried. Thus, it becomes practicable to reduce transmission loss of light, as with optical fibers. In this case, a semicircular shape convex toward one side opposite to the PWB 45 side may also be adopted.

In the formation of the transparent passage 58, the stepped recess 66 composed of the first-step recess 66a, 66c located at the lower step and the second-step recess 66b, 66d located at the upper step is formed at the upper surface of the light shielding resin 47, and the transparent resin is potted to the first-step recess 66a, 66c to form the transparent passage 58 while the light shielding resin is potted to the second-step recess 66b, 66d to form the upper surface of the light shielding resin 47. Therefore, the transparent passage 58 can be buried easily into the light shielding resin 47.

Consequently, according to this embodiment, an optical distance measuring device which is small-sized and which is capable of achieving high-accuracy distance measurement even under environments of intense temperature changes can be provided.

Now, another manufacturing method for the optical distance measuring device 41 of this embodiment is explained below. First, in the same manner as in FIGS. 20A to 24B, a transparent passage 58 is formed in the first-step recess 66a, 66c in the stepped recess 66 formed at the upper surface of the light shielding resin 47.

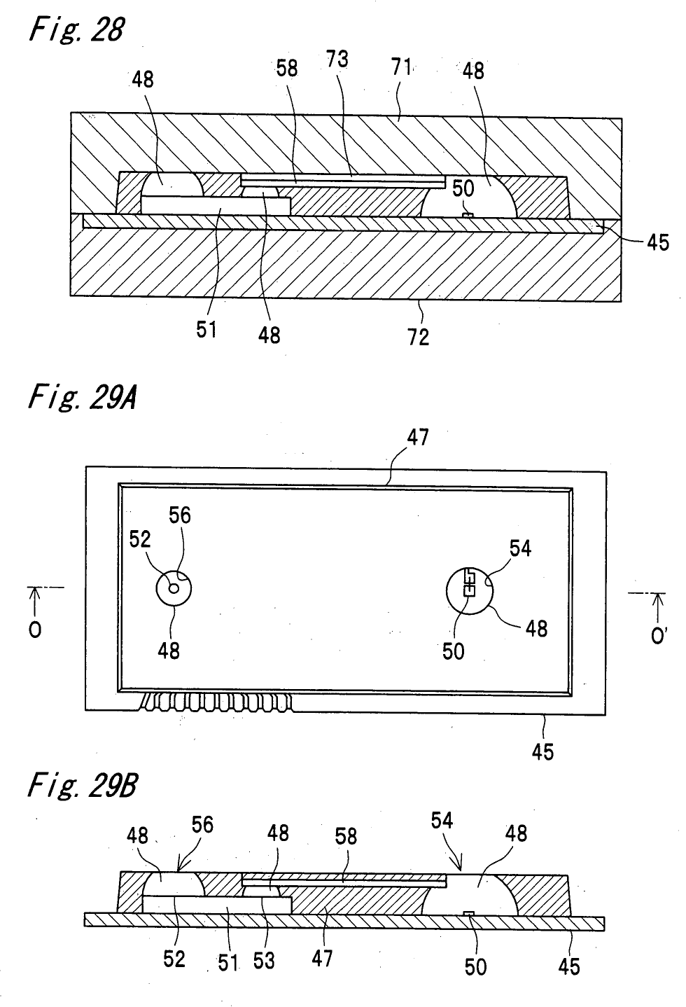

Next, the transparent resin is buried into the plate-shaped light shielding resin 47. FIG. 28 is a longitudinal sectional view showing a state in which the PWB 45 is placed within mold dies 71, 72 for burying of the transparent resin into the plate-shaped light shielding resin 47. In this state, a light shielding resin in which epoxy resin is mixed with a reflective additive such as silica is injected into a space 73 defined by the transparent resin 58 and the mold die 71 (i.e., a region of the second-step recess 66b, 66d in the stepped recess 66), and then subjected to transfer molding, by which the transparent passage 58 is buried into the plate-shaped light shielding resin 47. FIGS. 29A and 29B show the PWB 45 in a state that the transparent passage 58 has been buried into the plate-shaped light shielding resin 47 by transfer molding. In this case also, a PWB 45 having the absolutely same structure as the PWB 45 shown in FIGS. 25A and 25B are obtained. In addition, FIG. 29B is a sectional view taken along the line O-O′ of FIG. 29A.

From this on, as in the case of FIG. 27, the PWB 45 is placed within the mold dies 64, 65 for the formation of the first, second lenses 43, 44, and a transparent resin such as epoxy resin is injected into the space defined by the PWB 45 and the mold die 64 and subjected to transfer molding, by which the first, second lenses 43, 44 are formed.

As described above, in this manufacturing method, the PWB 45 is placed within the mold dies 61, 62, and a light shielding resin in which epoxy resin is mixed with a reflective additive such as silica is injected and subjected to transfer molding, by which the plate-shaped light shielding resin 47 with the stepped recess 66 formed at its surface is formed. Thereafter, a transparent resin such as silicone resin is potted and cured into the first-step recess 66a, 66c in the stepped recess 66 on the light shielding resin 47, by which the transparent passage 58 is formed. Thereafter, the PWB 45 is placed within mold dies 71, 72, and a light shielding resin in which epoxy resin is mixed with a reflective additive such as silica is injected and subjected to transfer molding, by which the transparent passage 58 is buried in the plate-shaped light shielding resin 47. Therefore, as compared with the case where the light shielding resin is potted and cured into the second-step recess 66b, 66d in the stepped recess 66, the transparent passage 58 can be surrounded on its periphery by a light shielding resin having the absolutely same optical characteristics, making it possible to further reduce the transmission loss of light in the transparent passage 58.

In the manufacturing method for the optical distance measuring device 41 shown in FIG. 28, the stepped recess 66 is formed as in the case of the manufacturing method for the optical distance measuring device 41 shown in FIGS. 20A to 27. However, in the manufacturing method shown in FIG. 28, without doing the potting two times, the light shielding resin is transfer molded within the mold dies. For this reason, the recess for the formation of the transparent passage 58 does not necessarily need to be a stepped recess.

Further, in the manufacturing method for the optical distance measuring device 41 shown in FIG. 28, the transparent passage 58 is formed by potting the transparent resin into the first-step recess 66a, 66c in the stepped recess 66. However, needless to say, with the PWB 45 placed within the mold dies, the transparent resin may be transfer molded to form the transparent passage 58.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An optical distance measuring device comprising:
a light emitting element;
a light receiving element for receiving light emitted from the light emitting element;
a first optical system for forming a first optical path which allows light emitted from the light emitting element to be reflected by a measuring object so as to reach the light receiving element;
a second optical system for forming a second optical path which allows light emitted from the light emitting element to reach the light receiving element without being reflected by the measuring object; and
distance information calculation means for obtaining distance information as to a distance ranging to the measuring object based on a signal outputted from the light receiving element upon reception of light that has passed through the first optical path and a signal outputted from the light receiving element upon reception of light that has passed through the second optical path, wherein
the second optical system includes a transparent resin which is in direct contact with a light emitting part of the light emitting element and a light receiving part of the light receiving element to lead part of light emitted from the light emitting part to the light receiving part.

2. The optical distance measuring device as claimed in claim 1, wherein
the light receiving part of the light receiving element is provided in plurality, some of the plurality of light receiving parts being optically coupled with the first optical system and the others of the light receiving parts being optically coupled with the second optical system.

3. The optical distance measuring device as claimed in claim 1, wherein
the second optical system is optically isolated from the first optical system by a light shielding resin.

4. The optical distance measuring device as claimed in claim 3, including:
a first lens for a light emitting element and a second lens for a light receiving element, the first lens and the second lens forming part of the first optical system and being formed of a transparent resin on the light shielding resin;
a first transparent resin which forms part of the first optical system and which is in direct contact with the light emitting element;
a second transparent resin which forms part of the first optical system and which is in direct contact with the light receiving element; and
two windows provided in the light shielding resin just under the first lens and the second lens, wherein
the first lens and the first transparent resin are in direct contact with each other via one of the windows provided in the light shielding resin, and
the second lens and the second transparent resin are in direct contact with each other via the other of the windows provided in the light shielding resin.

5. The optical distance measuring device as claimed in claim 1, wherein
the light emitting element is a light emitting diode.

6. The optical distance measuring device as claimed in claim 1, wherein
the light emitting element is a vertical cavity surface emitting laser, and
a portion of the transparent resin that forms part of the second optical system and that is in direct contact with the light emitting part of the light emitting element is a scattering transparent resin.

7. A method for manufacturing the optical distance measuring device as defined in claim 3, the method including:
forming, by potting, the transparent resin that forms part of the second optical system; and
forming the light shielding resin by casting or transfer molding.

8. The method for manufacturing the optical distance measuring device as claimed in claim 7, wherein
the light receiving part of the light receiving element is provided in plurality, some of the plurality of light receiving parts being optically coupled with the first optical system and the others of the light receiving parts being optically coupled with the second optical system, and
a wall which inhibits the transparent resin from spreading therebeyond in the potting process is provided between the light receiving parts optically coupled with the first optical system and the light receiving parts optically coupled with the second optical system.

9. The optical distance measuring device as claimed in claim 3, wherein
in the transparent resin that forms part of the second optical system,
both end portions of the transparent resin are in direct contact with the light emitting part of the light emitting element and the light receiving part of the light receiving element and serve as optical coupling parts optically coupled with the light emitting part and the light receiving part, respectively,
both end portions of a transparent passage defined by the two optical coupling parts are opposed to the light emitting part and the light receiving part, respectively, via the optical coupling parts, and
the transparent passage is surrounded on its periphery by the light shielding resin.

10. The optical distance measuring device as claimed in claim 9, wherein
the transparent passage in the transparent resin has a semicircular-shaped cross-sectional configuration, and
the light shielding resin is formed by containing a light-reflective material.

11. A method for manufacturing the optical distance measuring device as defined in claim 9, including:
forming the light shielding resin so that the light shielding resin has, at a surface thereof, a stepped recess a cross-sectional configuration of which is a two-stepped structure over a range from a proximity of the light emitting element to a proximity of the light receiving element;
potting and curing the transparent resin within a first-step recess in the stepped recess provided at the surface of the light shielding resin; and
thereafter potting and curing the light shielding resin within a second-step recess in the stepped recess, whereby
the transparent passage surrounded on its periphery by the light shielding resin is formed.

12. A method for manufacturing the optical distance measuring device as defined in claim 9, including:
forming the light shielding resin so that the light shielding resin has, at a surface thereof, a recess over a range from a proximity of the light emitting element to a proximity of the light receiving element;
potting and curing the transparent resin up to a less-than-full depth within the recess provided at the surface of the light shielding resin; and
thereafter placing, within a mold die, a substrate on which the light shielding resin and the transparent resin are formed, and injecting the light shielding resin onto the transparent resin within the recess, followed by transfer molding, whereby
the transparent passage surrounded on its periphery by the light shielding resin is formed.

13. A method for manufacturing the optical distance measuring device as claimed in claim 9, including:
forming the light shielding resin so that the light shielding resin has, at a surface thereof, a recess over a range from a proximity of the light emitting element to a proximity of the light receiving element;
placing, within a first mold die, a substrate on which the light shielding resin is formed, and injecting the transparent resin up to a less-than-full depth within the recess provided at the surface of the light shielding resin, followed by transfer molding; and
placing, within a second mold die, the substrate with the transparent resin formed thereon, and injecting the light shielding resin onto the transparent resin within the recess, followed by transfer molding, whereby
the transparent passage surrounded on its periphery by the light shielding resin is formed.
